(19) United States
(12) Patent Application Publication
(10) Pub. No.: US 2021/0168071 A1
(43) Pub. Date: Jun. 3, 2021

(54) MANAGEMENT OF THE APPLICATION OF A POLICY IN AN SDN ENVIRONMENT OF A COMMUNICATIONS NETWORK

(71) Applicant: Orange, Paris (FR)

(72) Inventor: Jamil Chawki, Chatillon Cedex (FR)

(21) Appl. No.: 17/256,934

(22) PCT Filed: Jun. 27, 2019
(86) PCT No.: PCT/FR2019/051586

§ 371 Date: Dec. 29, 2020

(30) Foreign Application Priority Data
Jul. 3, 2018 (FR) 1856129

(51) Int. Cl. H04L 12/721; H04L 12/717; H04L 12/713; H04L 12/46

(52) U.S. Cl. CPC H04L 45/566; H04L 12/4633; H04L 45/586; H04L 45/42

(57) ABSTRACT

A method for managing an enforcement rules policy in a virtualized communications network comprising virtualized functions, called service functions, is disclosed. In one aspect, the method is implemented by an SDN controller of the network and comprises: generating, from a set of rules describing the policy, called a model, an encapsulation header comprising a context relative to the model and to at least one policy enforcement local context associated with at least one of the service functions (SFi); forwarding of the at least one local context to the at least one service function (SFi); and forwarding of the encapsulating header to at least one packet router, called a classifier.

### CROSS-REFERENCE TO RELATED APPLICATIONS

This application is filed under 35 U.S.C. § 371 as the U.S. National Phase of Application No. PCT/FR2019/051586 entitled “MANAGEMENT OF THE APPLICATION OF A POLICY IN AN SDN ENVIRONMENT OF A COMMUNICATIONS NETWORK” and filed Jun. 27, 2019, and which claims priority to FR 1856129 filed Jul. 3, 2018, each of which is incorporated by reference in its entirety.

### BACKGROUND

### Field

The field of the invention is that of the virtualizing of the functions in a telecommunications network. More specifically, the invention relates to the management of an enforcement rules policy via virtualized software functions in an SDN (Software-Defined Networking) architecture.

### Description of the Related Technology

It may be recalled that the SDN architecture proposes to decouple the network control functions from the data-conveying functions proper, so as to enable the control of the network by programmable software functions and isolate the underlying infrastructure from the network of applications and network services. According to the Y.3300 recommendation (“Framework of software-defined networking”) of the ITU-T (International Telecommunication Union-Telecommunication) standardization organization, the SDN architecture is defined as a set of techniques used to directly program, orchestrate, control and manage the resources of the network, which facilitates the design, supply and operation of network services.

The SDN control layer or SDN controller enables the dynamic controlling of the behavior of the resources/elements of the network according to the instructions of an SDN application. The SDN application specifies the way in which the network resources must be controlled and allocated, in interacting with the SDN control layer via the NBI (northbound interface) application control interfaces.

The pieces of command information from the SDN control layer towards the network resources/elements are then delivered through SBI (southbound interface) resource control interfaces.

This SDN architecture thus enables the implementing of a software platform (called an SDN platform) that is programmable and flexible, offering an overall and logical view of the network and a dynamic management of the heterogeneous resources of the network.

More specifically, and with reference to FIG. 1, the SDN architecture is structured in three main layers separated from one another by SBI and NBI interfaces, namely:
a network resources layer constituted by physical or virtual NE or network elements, for example routers, switches, content delivery networks or CDNs;
a controller SDN-CTRL comprising abstraction and programming functions for the network elements NE of the network resources layer and offering basic service managers, for example for the management of nodes and the associated links;
a network applications NAP services layer comprising a set of management applications (for example management of virtual private networks or VPNs), supervision, connectivity to a cloud network platform.

In such an SDN architecture, a service function SF designates a function embedded in an environment that can be co-located with other service functions within the same device, such as for example a router, a server, a switch, etc. A service function or SF corresponds for example to a network address translation (NAT) function, a firewall function, a transmission control protocol optimizer or TCP optimizer function, a malware detection and elimination function, a parental control function, a cache optimizing function, a deep packet inspection (DPI) function, a load balancing function, etc.

Besides, service functions chaining or SFC, as described in the document IETF RFC 7665 (Internet Engineering Task Force Request For Comments 7665), simplifies the deployment of service functions or SF. A service functions domain enables the implementing of this chaining by supplying a plurality of service functions SF that can be linked to one another to provide a service. This domain is attached to service function classifiers that classify the traffic flows and decide which packet or packets enter a chain of the domain, through rules given by the SDN controller.

An example of one such SFC domain, illustrated in FIG. 2, comprises especially the following components:
a classifier SCL making it possible, as described here above, to determine which packet(s) must enter a service function chain, from a policy table;
a service function forwarder or SFF redirecting the packets towards the appropriate service function SF on the basis of SFC encapsulation information;
a service functions proxy SFP managing the SFC encapsulation information for the SFC-una (or unaware) non-compatible service functions SF;
a plurality of service functions SF responsible for the specific processing of the packets.

These different components manage for example a graph defined by a user, via an application, this graph describing a service functions chaining SFC in which each node of the graph is a service function SF.

In particular, the service functions chaining SFC therefore enables the defining of an ordered list of network service functions thus creating a service functions chain or chaining through which a packet must pass.

To this end, the service functions chaining SFC relies on the SFC encapsulation header which provides information on the service functions chaining through which the packet of the traffic flow must pass. The NSH (Network Service Header) as described in the document IETF RFC 8300, is an example of SFC encapsulation that defines a complete service plane carrying service function information.

This NSH header is added, by a classifier, to the packets of a traffic stream and indicates the SFs (firewall, DPI, load balancing or distribution, etc.) that they must pass through. An NSH header is composed especially of the following elements illustrated in FIG. 3:
Base Header (B.H.): comprises information on the service header and the payload protocol;
Service Path Header (S.P.H.): reflects the selection of a path identified by a service path identifier or SPI. The location of the packet in the path is given by the service index SI. The identifier SPI and the service index SI tell the packet which path to follow without necessitating the configuration of the metadata or of packet information;
Context Header (C.H.): carries metadata relative to a path that can be shared by the service functions SF.

The NSH encapsulation enables especially a service chaining independent of the topology of the network in providing the path identifying information needed to set up a service functions path.

In addition, the NSH encapsulation gives a mechanism for the transport of metadata shared between the entities of the network (classifiers, service function forwarders, etc.) and the service functions (SF). Thus, the sharing of metadata enables the service functions (SF) to share the results of the initial and intermediate results of classification with the service functions (SF) further down a path.

The semantics of the metadata are communicated via a control layer to the participant nodes of a network.

Finally, the NSH encapsulation is independent of the transport encapsulation in the network and the NSH header therefore constitutes a common and standard header for the chaining of service functions throughout the network. The NSH encapsulation therefore enables the defining of flexible chains of service functions in an application-directed service plane.

Besides, there are known ways of defining policies applicable to elements or groups of elements or physical devices of a network, for example via a component of the SDN controller called a group-based policy (GBP) module.

Each device of the network (for example a host machine, a machine port, a virtual machine, etc.) is seen as an endpoint. Several endpoints can be grouped according to common policy rules and thus form endpoint groups. Contracts define the ways in which the endpoints and/or the endpoint groups can communicate.

In the prior art of the technique of virtualization of functions of an SDN network, the enforcement of a policy is centralized and requires that a service function SF should forward the packet to the controller which, for its part, returns to it the actions of the policy to be implemented: this leads to a large number of exchanges between the controller and the service functions SF. In addition, when a policy has to be put into application, the configuration of each service function SF must be modified for all the nodes of the network concerned by the policy, or else this requires the instantiation of a new chain of service functions.

The present techniques therefore do not allow the granular and dynamic management of an enforcement policy that enables the targeting of all the endpoints of the network, without having to allocate new resources (in terms of computation and storage resources).

The present technique proposes a mechanism for the management of an enforcement policy in a network that does not have these drawbacks.

### SUMMARY OF CERTAIN INVENTIVE ASPECTS

The present invention relates to a method for managing an enforcement rules policy in a virtualized communications network comprising virtualized functions, called service functions SF, comprising the following steps implemented by an SDN controller of the network:
generating S1, from a set of rules describing the policy, called a model M, of an encapsulation header comprising a context relative to the model M and to at least one policy enforcement local context associated with at least one of the service functions SFi;
forwarding S2 of the local context to the service function SFi;
forwarding S3 of the encapsulating header to at least one packet router, called a classifier (SCL).

According to one particular aspect, the step of generating comprises the following sub-steps:
obtaining, from the model M, of at least one set of rules for processing packets by at least one of the service functions SFi, called an enforcement policy chain EC1;
obtaining, from the enforcement policy chain EC1, of a context header and of the policy enforcement local context for at least one of the service functions SFi;
generating the encapsulation header from the content header.

For example, the enforcement policy chain EC1 describes at least one chaining SFC1 of at least one of the service functions SFi according to at least one piece of information representative of a predefined set of communications rules, called a contract, between a first and second group of devices of the communications network, EPG1, EPG2, the first group EPG1 comprising at least one device that is the sender of at least one packet and the second group EPG2 comprising at least one device that is the intended recipient or destination of least one packet and/or of at least one piece of information representative of at least one device EP10 in the first group EPG1 and/or of at least one packet characteristic.

According to one particular characteristic, the local context comprises at least one definition of at least one action to be performed by the service function SFi.

According to one particular embodiment, the forwarding of the encapsulation header to at least one classifier SCL comprises a step of configuration of the service classifier SCL so that the service classifier SCL delivers, for at least one incoming packet, at least one packet enriched with the encapsulation header.

According to another aspect, the present invention relates to a method for processing an enforcement rules policy in a communications network comprising virtualized functions, called service functions SF, comprising, in at least one of the service functions SFi, a preliminary step of reception S4, from an SDN controller of the network, of a policy enforcement local context associated with the service function SFi, and the following steps:
reception S5 of at least one packet enriched with an encapsulation header by a packet router, called a classifier SCL of the network;
processing S6 of the enriched packet in taking account of the policy enforcement local context associated with the service function SFi.

According to one particular characteristic, the processing comprises a step of execution of at least one action defined by a policy enforcement local context, in taking account of at least one characteristic of the enriched packet and delivering a result comprising at least one piece of information for identifying at least one service function SFj that is the intended recipient or destination of the processed enriched packet.

According to one particular embodiment, the processing also comprises a step of updating the encapsulation header as a function of the result of the step of execution.

According to another aspect, the invention relates to an SDN controller module comprising:
means for generating, from a set of rules, called a model M, describing an enforcement rules policy in a virtualized communications network comprising virtualized functions called service functions SF, an encapsulation header comprising a context relating to the model M and to at least one policy enforcement local context associated with at least one of the service functions SFi;
means of forwarding of the local context to the service function SFi;
means of forwarding of the encapsulation header to at least one packet router, called a classifier (SCL).

The SDN controller module is especially capable of implementing the step of the method for managing an enforcement rules policy as described here above and here below according to its different embodiments.

The present invention also relates to a virtualized function module, called a service function module, in a virtualized communications network comprising a policy enforcement logic module (PEL) comprising:
means of reception, from the SDN controller of the network, of a policy enforcement local context associated with a service function module;
means of reception of at least one packet enriched with an encapsulation header by a packet router, called a classifier SCL of the network;
means of processing of the enriched packet in taking account of the policy enforcement local context.

The policy enforcement logic module (PEL) is especially capable of implementing the steps of the method for processing of an enforcement rules policy as described here above and here below according to its different embodiments.

According to yet another aspect, the invention relates to a system comprising an SDN controller module and a service function module as described here above and here below according to its different embodiments, as well as a packet router, called a classifier SCL, receiving an encapsulation header from the SDN controller and delivering, for at least one incoming packet, at least one packet enriched with the encapsulation header.

Another aspect relates to one or more computer programs comprising instructions for the implementing of a method of management and/or a method of processing of an enforcement rules policy as described here above and here below when one of these programs is executed by at least one processor.

According to another aspect, the invention proposes one or more non-transient recording media readable by a computer and comprising instructions of one or more computer programs comprising instructions for the implementing of a method of management and/or a method of processing of an enforcement rules policy, as described here above and here below, when one of these programs is executed by at least one processor.

### BRIEF DESCRIPTION OF THE DRAWINGS

Other aims, features and advantages of the invention shall appear more clearly from the reading of the following description, given by way of a simple, illustratory and non-exhaustive example with reference to the figures of which:

FIG. 1 already described represents the prior-art SDN architecture;

FIG. 2 already described represents an example of a prior-art SFC domain;

FIG. 3 already described represents an example of contents of an NSH header of the prior art;

FIG. 4a illustrates the main steps of the method for managing an enforcement rules policy according to one embodiment of the invention;

FIG. 4b illustrates the main steps of the method for processing an enforcement rules policy according to one embodiment of the invention;

FIG. 5 illustrates an example of integration, into an SDN architecture, of the method and modules for managing an enforcement rules policy according to one embodiment of the invention;

FIG. 6 illustrates an example of a chain of an enforcement rules policy according to one embodiment of the invention;

FIG. 7 illustrates an example of a policy enforcement logic module/plug-in (PEL) of a service function SF according to one embodiment of the invention;

FIGS. 8 and 9 respectively illustrate, for one example of implementation of the invention, the entities of a network and an enforcement rules policy chain according to one embodiment of the invention.

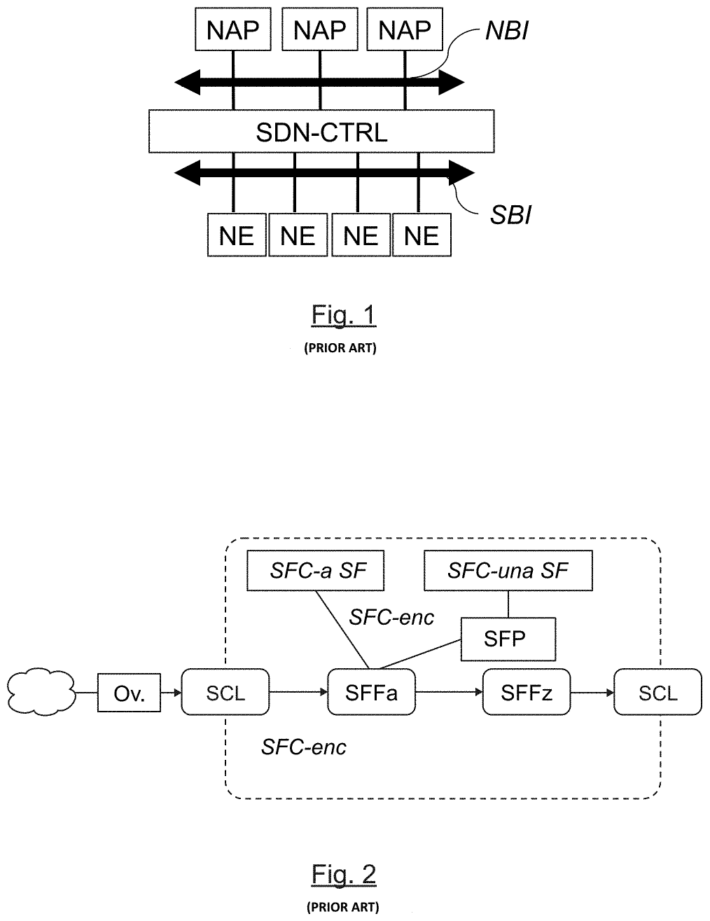

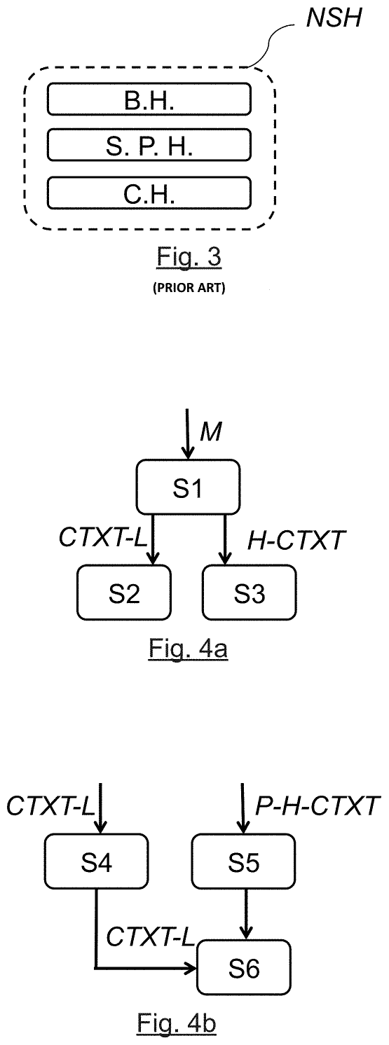

### DETAILED DESCRIPTION OF CERTAIN ILLUSTRATIVE EMBODIMENTS

The general principle of the proposed technique relies on cooperation between the transfer plane and the control plane in a virtualized communications network comprising virtualized functions, or service functions.

This cooperation is especially implemented, on the one hand, via the taking into account, for the transfer of the packets, of a context relating to a set of rules describing a policy and, on the other hand, via the taking into account of a local context at each service function.

Thus, the proposed technique enables the management of a chaining of service functions to apply the rules of the policy in a dynamic and distributed way as compared with prior-art techniques.

In addition, the proposed technique is based on a modelling of an enforcement rules policy in a network, in order to carry out a contextualized management of this policy at the level of the requisite network functions.

To this end, the proposed technique relies for example on an existing SDN architecture and on the known functionalities of service function chaining.

Thus, according to the proposed technique, a model defined by a user such as a set of rules describing an enforcement rules policy is interpreted by the SDN controller which translates it into technical configurations via the creation especially of a chain of service functions, corresponding to a set of rules for processing packets by a service function and actions to be implemented by the service functions of the chain.

This chain of service functions, called an enforcement policy chain, can be created in the form of an enforcement policy graph which is processed for example by an enforcement policy module, in the SDN controller, so as to deliver a plurality of local contexts intended for the working of each of the service functions of the predefined chain.

In this way, the management of a new enforcement rules policy does not require the instantiation of new resources because the local context associated with each service function enables the granular or fine-grained management of the overall policy.

Indeed, through this local context, each service function has its own “intelligence” or “smartness” available to it, enabling it to implement the appropriate actions defined by the model.

The proposed technique therefore enables a chaining of enforcement rules policy distributed at the level of each service function, via an enforcement policy module which manages the local context received and the enforcement policy actions. This enforcement policy module enables the selection, via the model preliminarily interpreted by the SDN controller, of the appropriate action, based on the preliminarily defined enforcement policy chain. This enforcement policy module of a service function also makes it possible, in addition, to tell the next service function which will be the next enforcement policy action to be implemented.

The proposed technique can easily be implemented in a model-oriented type of environment such as OpenDaylight or ONOS. Indeed, these techniques propose an SDN controller capable of communicating to physical and virtual devices via different interfaces and protocols (Netconf, OpenFlow, OVSDB, etc.), integrating in particular the service function chaining (SFC) modules with the NSH packet protocol as well as a group-based policy (GBP) module already described here above.

More specifically, the proposed technique is based on the NSH protocol and more particularly the NSH context header stipulated in the standard but not defined which enables the transportation of metadata proper to the service delivered. The proposed technique enables the structuring of these metadata on the basis of models of a model that expresses the cases of client use of enforcement policy in a simple and service-independent manner (independently of the network, of the virtual elements or physical elements implemented, of the transportation protocol, etc.).

The proposed technique therefore enables the management of an enforcement policy at the level of a service function, starting with a model that makes it possible to overlook the complexity of configuration of the network and of the different service functions to be implemented, and makes it possible to focus on the expression of the functional need from an applications viewpoint (for example prohibiting subscribers of a mobile network from having access to certain Internet sites).

Referring to FIG. 4a, we first describe the main steps of the method of management of an enforcement rules policy in a communications network comprising virtualized functions, called service functions SF, implemented in a device corresponding to an SDN controller of the network, according to a first embodiment of the proposed technique.

As already indicated here above, the proposed technique makes good use of a description by a model M of a network enforcement rules policy, said model therefore corresponding to a set of rules describing this policy.

At a step S1, the SDN controller generates an encapsulation header comprising a context relative to the model, as well as at least one local context associated with at least one service function of the network.

At the steps S2 and S3, the SDN controller forwards the local context to the service function with which it is associated, in order to ensure the processing of the packets, and forwards the encapsulation header to at least one packet router, or classifier (SCL), in order to ensure the transfer of the packets.

More specifically, the step of generating S1 comprises a sub-step for obtaining at least one enforcement policy chain EC1 corresponding to a set of rules for processing packets by means of at least one service function, from the model M described here above.

Such an enforcement policy chain EC1 describes at least one chaining SFC1 of at least one of the service functions (SF) of the given domain as a function of at least one piece of information representative of:
a predefined policy contract between a first and a second group of devices or endpoints EPG1, EPG2, of the communications network, such a contract corresponding to a predefined set of rules of communications between the two groups;
at least one endpoint EP10 in a first group EPG1;
at least one packet characteristic, such as for example an indication of the fact that the packet is an Internet packet.

Indeed, when the device, via its application, has defined the policy rules in the contracts between endpoint groups, it can define the chaining of the service functions to be implemented for the enforcement policy via one or more enforcement policy chains ECi.

Thus, each enforcement policy chain ECi is related to a given contract between two endpoint groups and concerns solely the endpoints that comply with the particular requirements/clauses.

The step of generating S1 also comprises a sub-step for obtaining, from the enforcement policy chain (EC1), a context header and a policy enforcement local context for at least one service function.

Then, a sub-step of generating of an encapsulation header is implemented, on the basis of the context header, so that the encapsulated packets carry this context header.

Thus, each packet to be transferred into the network is modified, by one of the classifiers (SCL) of the network, by encapsulation, and each service function has received a local context enabling it to implement appropriate actions required by the model describing the enforcement rules policy.

When several service functions are present in a network, which is the case in general (for example a packet inspection service function, a firewall service function, etc.), several local contexts are obtained and associated with each of these service functions.

Referring now to FIG. 4b, we describe the main steps of the method for processing an enforcement rules policy for applying rules in a communications network comprising virtualized functions, called service functions SF, implemented in at least one service function SFi of the network, according to a first embodiment of the proposed technique.

At a preliminary step of reception S4, the given service function SFi receives, from the SDN controller of the network, a policy enforcement local context that is associated with it (i.e. one of the local contexts obtained during the step S1 described here above).

This local context is used by the service function to process each packet that it receives.

Thus, during a reception step S5, the service function receives at least one packet enriched with an encapsulation header by a packet router or classifier SCL of the network, and processes it at a processing step S6 in taking account of the associated policy enforcement local context.

According to this embodiment, the processing applied to the enriched packet by the service function corresponds for example to a step of execution of at least one action defined in the policy enforcement local context, in taking account of at least one characteristic of the enriched packet received. For example, the type of packet enables the selection of the action to be executed, just like the packet-sending device or again the chain of service functions associated with it.

The execution of an action delivers especially a result comprising at least one piece of information for identifying at least one destination service function SFj of the processed enriched packet, on the basis of encapsulation header information, information on local context and characteristics of the packet.

In addition, the processing of the packet also comprises a step for updating the encapsulation header according to the execution of the action, especially to modify, if necessary, the path defining the subsequent service functions to be implemented.

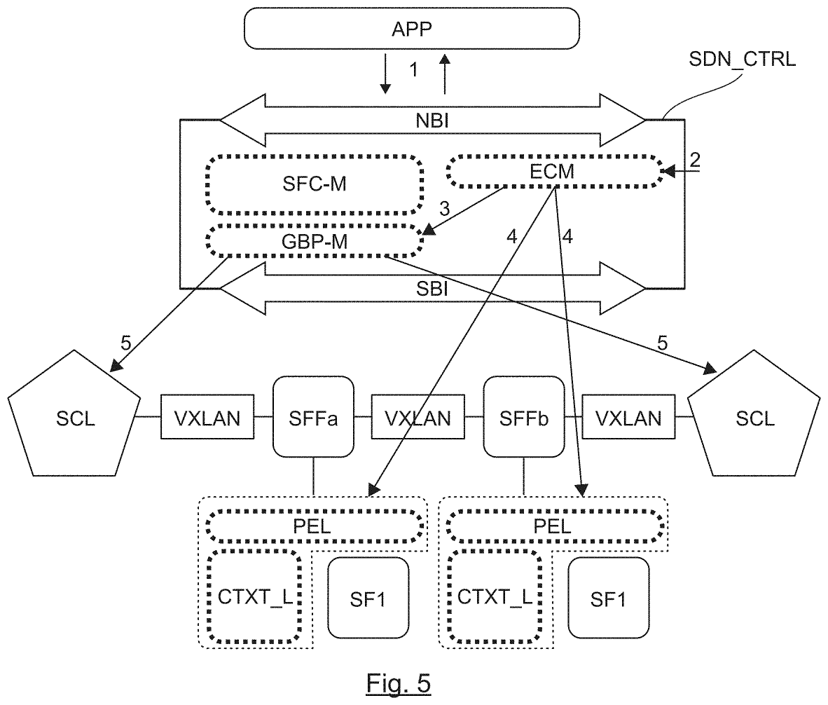

As described here below with reference to FIG. 5, the proposed technique implements an enforcement policy chaining module ECM at the SDN controller as well as a policy enforcement logic module PEL at each service function.

The applications policy chaining module ECM is especially in charge of obtaining the context header and the local context and forwarding them respectively to at least one classifier, with a view to an encapsulation of the packets, and to the policy enforcement logic module PEL of each service function SF concerned.

According to one particular implementation of the proposed technique, this context header corresponds precisely to the context header of the NSH header. The taking into account of this header by a classifier corresponds therefore to an NSH encapsulation of the packet, so that the metadata transported in the NSH context header can be interpreted by the service function forwarders SFF with a view to the forwarding of the packet to the appropriate service function.

These main steps therefore make it possible, from a model of an enforcement rules policy in a network, to obtain the granular and distributed enforcement of this policy, at each service function of the domain, by means of dynamic enforcement policy chains and the management of a local context for each service function.

The more detailed steps and the interactions between the different elements are described here below, with reference to FIG. 5.

As already indicated here above, the implementing of the proposed technique is situated at the SDN controller, through an enforcement policy chaining module ECM as well as a level of each service function SF through a policy enforcement logic module PEL.

The first step 1, once the model has been defined by the user, consists therefore in receiving, in the SDN controller, an “intention” for a chaining of service functions. Indeed, the principle of the module is to define intentions without taking account of the technical constraints/characteristics of the network, thus enabling great facility of use and of definition.

This model is received by the SDN controller via the applications control interfaces (NBI), and is then interpreted to define a chaining of service functions and associated actions. This interpretation is implemented by an SFC-M module (Service Function Chaining Module) which does not have knowledge of the devices (or endpoints) of the network but knows the point from which it must start and the point at which it must arrive. The knowledge of the devices is controlled by the grouped policy management module GBP-M.

The interpretation of the model therefore delivers one or more enforcement policy chains ECi describing at least one chaining SFC1 of at least one of the service functions SF of the given domain.

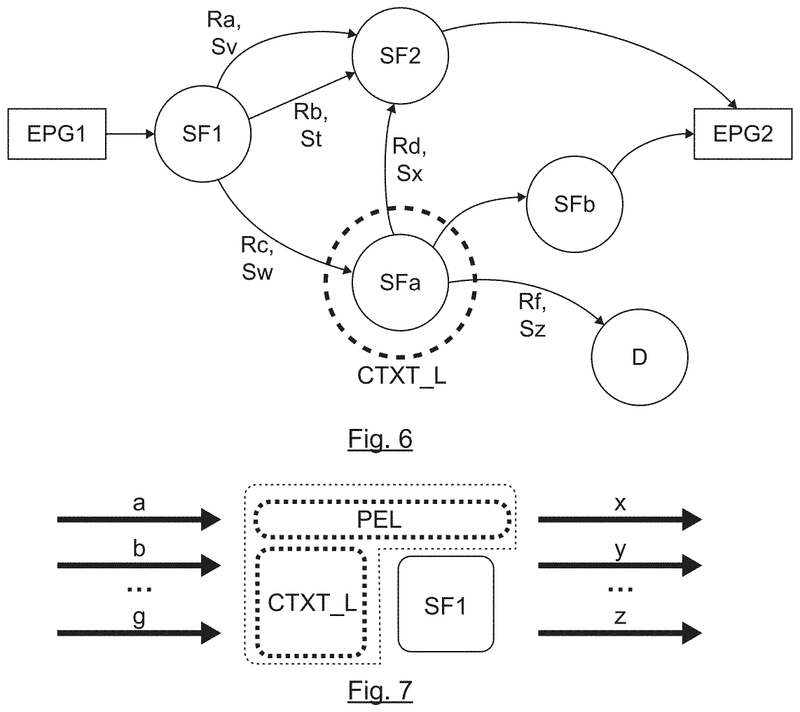

For example, the chains ECi are delivered in the form of enforcement graphs as described here below with reference to FIG. 6.

Then, in a step 2, the enforcement policy chaining module ECM stores the enforcement rules policy graph, in storing on the one hand the general chaining context and in distributing, on the other hand, local chaining contexts to each policy enforcement logic module PEL of the service functions of the domain.

To this end, the enforcement policy chaining module/plugin ECM creates clauses pertaining to the actions of the service functions (each clause corresponds to an action of a service function) and generates the NSH context corresponding to the enforcement policy chaining chosen. Examples of clauses and actions shall be described here below with reference to FIG. 6 too.

At a step 3, the enforcement policy chaining module/plug-in ECM sends the NSH context to the GBP-M module so that this module adds it to the NSH header which is sent, at a step 5, to the classifiers of the domain. These classifiers are indeed in charge of determining which packet of the stream must enter a given chain of service functions, on the basis of a policy table, and thus are in charge of encapsulating each packet with the right NSH header.

Besides, at a step 4, the enforcement policy chaining module ECM sends the policy enforcement local context to each policy enforcement logic module PEL of the service functions of the field.

Thus, for a set of rules of a given policy between two endpoints and a chaining used, the present technique makes it possible to define enforcement policy chains that can be applied to each service function, these chains having a set of possible actions to be performed and having knowledge of an enforcement policy chaining logic at a local level.

A more detailed description is now provided, referring to FIG. 6, of an example of an enforcement policy chain.

As illustrated in FIG. 6, each node of an enforcement policy chain ECi refers to a given chain of service functions SF (SFCi) and to a given service function (SFi). In addition, each node corresponds to enforcement policy actions to be implemented at the level of the given service function SFi (no specific treatment, rejection of the packet, execution of a function proper to the service function such as for example inspection of the packet if the service function is a packet inspector or addition of firewall rules if the service function is a firewall).

As already indicated, an enforcement policy chain ECi pertains to a given contract between two endpoint groups and can be applied solely to the packets that are concerned, i.e. the packets that comply with certain conditions especially defined in the context information described here below.

In the example illustrated in FIG. 6, we consider a contract contract1 defined between the two endpoint groups EPG1 and EPG2, the group EPG1 comprising for example two endpoints EP10 and EP11.

The domain comprises four service functions SF1, SF2, SFa and SFb, and the contract defines for example the following two chains of service functions:
SFC1: SF1->SF2 (chaining of service functions SF1 and SF2);
SFC2: SF1->SFa->SFb (chaining of service functions SF1, SFa and SFb).

Finally, an enforcement policy chain EC1 has been generated for the contract contract1, defining the clauses and actions described here below, by means of the NSH header and the local contexts associated with the different service functions.

For example, the context information carried by the NSH header are the following: an application A, a tenant B (the owner of the resources), the endpoints EP10 and EP11, the endpoint groups EPG1, the chains SFC1 and SFC2, as well as information on the service such as for example a characteristic indicating that it is an Internet traffic.

The enforcement policy chain EC1 therefore describes the different service function chainings according to the endpoint concerned, at least one characteristic of the packet and its content and describes the different actions of each service function according to the result of the preceding service function.

Thus, for each service function, a local context describes the different clauses defining the actions of the service function. These different clauses are especially stored in the service function and their interpretation and implementation are carried out by the policy enforcement logic module PEL of the service function concerned, as illustrated in FIG. 7 here below.

For example, for the service function SF1, the local context defines the following two clauses:
clause 1: {SFC1, Internet traffic, EP10}; this first clause indicates that an Internet type packet from the endpoint EP10 must be routed in the service function chain SFC1;
clause 2: {SFC1, Internet traffic, EP11}; this second clause indicates that a “Internet” type packet from the endpoint EP11 must be routed in the service function chain SFC1.

Besides, an enforcement policy action EA contains the action properly speaking that must be carried out by the service function SF to process the packet. Each action EA can generate an output and the following action EA can be implemented on the basis of the output of the preceding action EA. This logic is especially defined by the user in the model and is stored in the policy enforcement logic module PEL.

For the service function SF1, the actions defined in the clauses are for example the following:
clause 1: action EA1: “Action Inspect 1”: requires the inspection of the packet when it comes from the endpoint EP10, when it corresponds to the Internet traffic and when it must be routed in the chain of service functions SF1. This action can give two results “a” or “c”, comprising especially respectively the outputs “v” and “w” associated with a piece of information representative of the following service function which will process the packet in question, in the chain SF1; the results “v” and “w” can for example correspond respectively to the case where the inspection of the packet has revealed nothing abnormal and the case where the inspection of the packet has detected an anomaly;
clause 2: action EA2: “Action Inspect 2”: requires the inspection of the packet, when it comes from the endpoint EP11, when it corresponds to the Internet traffic and when it must be routed in the chain of service functions SF1. The result of this action is denoted as “b” and comprises especially the output “t” associated with a piece of information representative of the following service function which will process the packet in question in the chain SF1.

For the service function SF2, the local context defines for example the following three clauses:
clause 1: {SFC1, EP10, v}; this first clause indicates that a packet from the endpoint EP10, and for which the output of the processing by a preceding service function is equal to “v” must be routed in the service function chain SFC1;
clause 2: {SFC1, EP11, t}; this second clause indicates that a packet from the endpoint EP11, and for which the output of the processing by a preceding service function is equal to “t” must be routed in the service function chain SFC1;
clause 3: {SFC1, x}; this third clause indicates that a packet for which the output of the processing by a preceding service function is equal to “x” must be routed in the service function chain SFC1.

The actions defined in these clauses are the following:
clause 1: action EA1: “Action Deny”: denial or rejection of the packet (this packet is not processed and will not be forwarded to the group EPG2) when it comes from the endpoint EP10, when it must be routed in the service function chain SF1 and when the output of the preceding action was “v”;
clause 2: action EA2: “Action Allow”: allowing the packet (this packet does not undergo any treatment proper to a defined clause and is directly forwarded to the next service function), when it comes from the endpoint EP11, when it must be routed in the chain of service functions SF1 and when the output of the previous action was “t”;
clause 3: action EA3: “Specific Action”: this type of action corresponds to an action proper to a service function, such as for example the adding of firewall rules if the service function is a firewall, to be implemented in this example when the output of the previous action was “x”.

For the service function SFa, the local context defines the following clause:
clause 1: {SFC2, EP10, w}; this clause indicates that a packet from the endpoint EP10, and for which the output of the processing by a preceding service function is equal to “w” must be routed in the service function chain SFC2;
   and the following action:
action EA1: “Action DoS”: an attack by denial of service is detected and the packet is dropped (“Drop”), when it comes from the endpoint EP10, when it must be routed in the chain of service functions SF2 and when the output of the preceding action was “w”. The result of this action is “f” and comprises especially the output “z”. If the conditions of application of the clause are not fulfilled, then the packet does not note any attack by denial of service and the packet is forwarded to the service function SFb.

The description of the actions EA therefore reflects the functions of the service functions and can be modulated according to the different existing types of service functions.

FIG. 7 illustrates an example of a device corresponding to a policy enforcement logic module PEL for the service function SF1 coming into play in the enforcement policy chain EC1 described here above with reference to FIG. 6.

The local chaining context stored in this service function SF1 relates to all the information needed by the policy enforcement logic module PEL to:
manage the output of the preceding action EA (for example a, b . . . g);
send the right action to be performed to the service function proper, on the basis of the defined chaining logic;
receive the result of the action performed to be able to send the packet to the following service function, on the basis of the defined chaining logic, and in generating an output (for example x, y, z).

Thus, the proposed technique enables a granular, dynamic and distributed management of an applications policy that enables the targeting of all the endpoints of a network without allocating new resources (in terms of computation and storage resources). In addition, the proposed technique makes good use of the definition of a policy by a module, thus enabling great facility of use and definition, without needing to take the technical constraints/characteristics of the network into account.

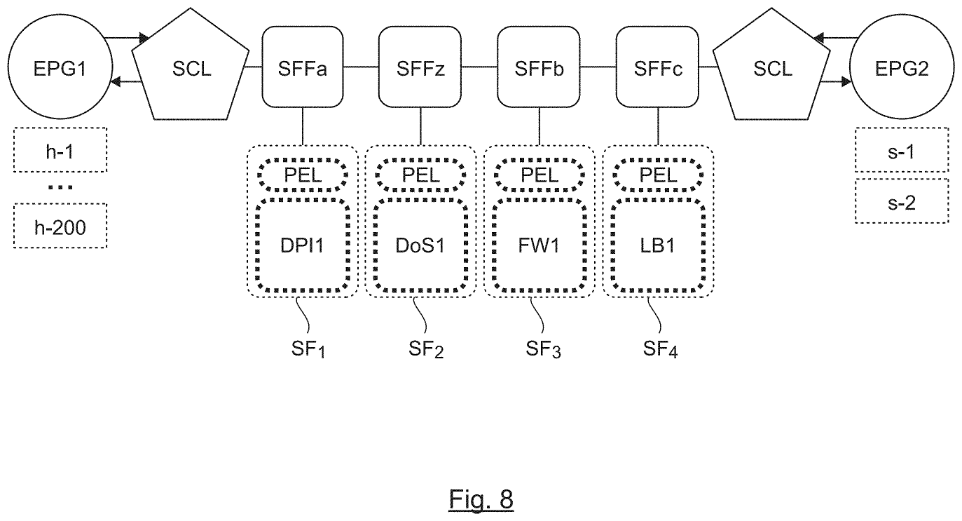

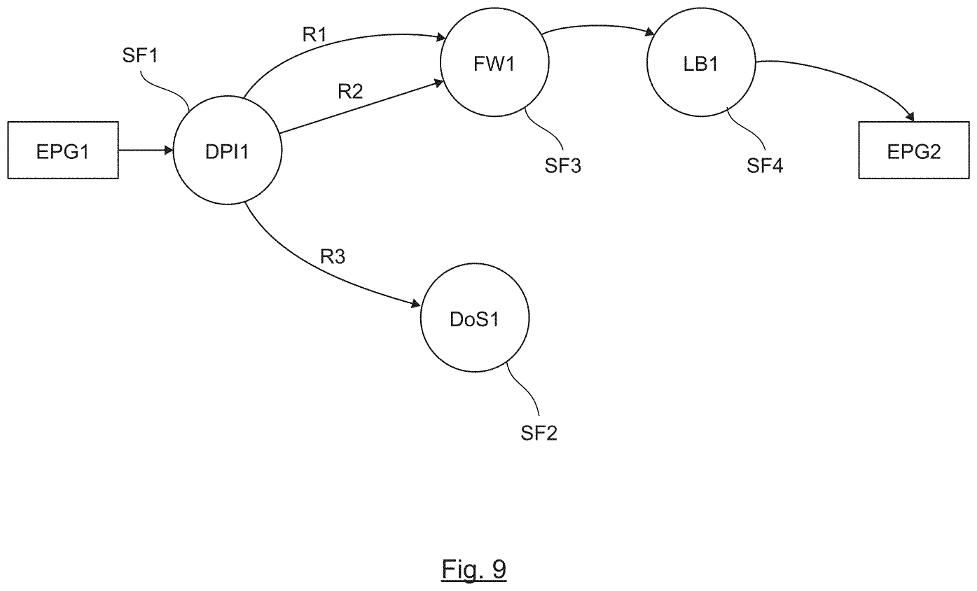

FIGS. 8 and 9 illustrate the example of a firm having a private network comprising client machines or devices h-1, . . . , h-200, belonging to a first group EPG1. These client machines have access to applications servers s-1, s-2, belonging to a second group EPG2.

The communications between these two groups are described by means of the GBP and SFC modules of an SDN controller, for example “OpenDaylight” in the form of a contract C1 and two chains of service functions “SFC-traffic” and “SFC-cleaner”.

The first chain “SFC-traffic” comprises the following two service functions: SF1 corresponding to a packet inspector DPI1, SF3 corresponding to a firewall FW1 and SF4 corresponding to a load balancer LB1,

The second chain “SFC-cleaner” comprises the following two service functions: SF1 corresponding to the packet inspector DPI1 and SF2 a traffic cleaner DoS1.

Thus, the packets exchanged between these two groups EPG1 and EPG2 are routed in the chain “SFC-traffic” and pass through the packet inspector DPI1 to retrieve information on network diagnostics, the firewall FW1 and a load balancer LB1.

The other service chain “SFC-cleaner” is defined when the packet inspector DPI1 detects a malicious behavior and enables the concerned packets to be got rid of.

Thus, the enforcement rules policy model makes it possible to determine that certain client machines of the group EPG1 must be subjected to an inspection of packets by the packet inspector DPI1 with a view to detecting a possible malicious behavior. Depending on the behavior detected, if this behavior is verified, the packets concerned will either have, dynamically allocated to them, the other service chain “SFC-cleaner”, which will convey the packets to the DoS1 traffic cleaner, or undergo restrictions on the part of the firewall FW1.

To enable the application of this logic, an enforcement policy chain EC1 is defined and illustrated in FIG. 9.

This enforcement policy chain EC1 makes it possible, granularly and dynamically, to submit for example the packets of the client machines h-1 and h-2 to a detection of malicious behavior and to get rid of suspicious packets. By contrast, the packets not concerned by the enforcement policy chain EC1 are processed as defined initially by the GBP and SFC modules.

Thus, for the enforcement policy chain EC1 associated with the contract C1, the clauses and actions are described here below, through an NSH header and through the local contexts associated with the different service functions.

For example, for the enforcement policy chain EC1, the pieces of context information carried by the NSH header are the following: an application A, a tenant B (owner of the resources), the client machines h-1 and h-2, the group of client machines EPG1, the chains SFC-traffic and SFC-cleaner.

This description of the contract and of the enforcement policy chain EC1 can be written as follows:
Contract name: C1
Endpoint Groups: EPG1, EPG2
Enforcement Chain: EC1
Context information: {Application A, tenant B, h-1/h-2, EPG: EPG1, SFC-traffic, SFC-cleaner}

Then, for the service function SF1 (DPI1), the local context defines the following packet inspection clause:
clause Inspect: {SFC-traffic, application A, tenant B, devices h-1/h-2}; this first clause does not include any indication on the packet and specifies that a packet from the device h-1 or h-2 must be routed in the service function chain SFC-traffic.

This description of the local context can be written as follows:

DPI1 local context chain:
ClauseInspect
{
chain: “SFC-traffic”,
app:“ApplicationA”
tenant: “tenant”
endpoints: [“h-1”,”h-2”]
Service_related: { }
}

Besides, an enforcement policy action EA contains the action properly speaking that is to be carried out by the service function SF1 to process the packet.

For the service function SF1, the actions defined in the clauses are for example the following:
clause Inspect: “Action Inspect”: requires the inspection of the packet when it comes from the device h-1 or h-2 and when it must be routed in the service function stream SFC-traffic. This action can give two results R1 or R3, corresponding respectively to the case where the inspection of the packet has revealed nothing abnormal (the packet is then forwarded to the next service function of the chain SFC-traffic, i.e. the service function SF3 (firewall FW1), with a list of restrictions restriction_list to configure the firewall) and to the case where the inspection of the packet has detected an anomaly, in which case the packet changes its service function chain and is routed in the chain SFC-cleaner, i.e. towards the service function SF2 (DoS1 cleaner);
clause Default: “Action Allow”: allowing the packet (this packet undergoes no processing proper to a defined clause and is directly forwarded to the next service function), when it comes from the device h-1 or h-2 and when it must be routed in the service function chain SFC-traffic. This action gives the result R2 and the packet is then forwarded to the next service function of the chain SFC-traffic, i.e. the service function SF3 (firewall FW1).

For the service function SF3 (the firewall FW1), local context defines the following enforcement clause for the enforcement of firewall rules:
Rules clause: {SFC-traffic, application A, tenant B, restriction_list}; this first clause specifies that a packet for which the output of the processing output by a preceding service function is equal to R1 (restriction_list) must be routed in the service function chain SFC-traffic.

This description of the local context can be written as follows:

FW1 local context chain:
ClauseRules
{
chain: “SFC-traffic”,
app:“ApplicationA”
tenant: “tenant”
Service_related: {

Output: {
restriction_list: [...]
}
}

}

For the service function SF3 (the firewall FW1), the actions defined in the clauses are for example the following:
Rules clause: “Action AddRules”: enforcement of firewall rules defined by the restriction_list and forwarding of the packet towards the next service function of the chain SFC-traffic, i.e. SF4 (load balancer LB1);
Default clause: “Action Allow”: allowing the packet (the one that does not undergo any processing proper to a defined clause and is directly forwarded to the next service function), when the output of the processing by a preceding service function is equal to R1 (restriction_list) and when it must be routed in the service function chain SFC-traffic. The packet is then forwarded to the next service function of the chain SFC-traffic, i.e. SF4 (load balancer LB1).

The service function SF2 (cleaner DoS1) for its part is in charge of verifying that the incoming packet is malicious and of eliminating it if such is the case.

Thus, we have seen that the packets from the devices h-1 or h-2 can be routed, according to their content, in the chain SFC-traffic or the chain SFC-cleaner (when they are detected as having malicious behavior) while the packets from the other devices of the group EPG1 are not concerned by the enforcement policy chain EC1.

1. A method of managing an enforcement rules policy in a virtualized communications network comprising virtualized functions, called service functions (SF), the method being implemented by an SDN controller of the network and comprising:
generating, from a set of rules describing the policy, called a model, an encapsulation header comprising a context relative to the model and to at least one policy enforcement local context associated with at least one of the service functions (SFi);
forwarding of the at least one local context to the at least one service function (SFi);
forwarding of the encapsulating header to at least one packet router, called a classifier.

2. The method of managing of claim 1, wherein generating comprises:
obtaining, from the model, at least one set of rules for processing packets by at least one of the service functions (SFi), called an enforcement policy chain EC1;
obtaining, from the enforcement policy chain, a context header and the at least one policy enforcement local context for at least one of the service functions (SFi); and
generating the encapsulation header from the content header.

3. The method of managing of claim 2, wherein the at least one enforcement policy chain describes at least one chaining of at least one of the service functions (SFi) according to at least one piece of information representative of a predefined set of communications rules, called a contract, between a first and second group of devices of the communications network, the first group comprising at least one device that is the sender of at least one packet and the second group comprising at least one device that is a destination of least one packet, and/or a piece of information representative of at least one device in the first group and/or at least one packet characteristic.

4. The method of managing of claim 1, wherein at least one local context comprises at least one definition of at least one action to be performed by the at least one of the service functions (SFi).

5. The method of managing of claim 1, wherein the forwarding of the encapsulation header to at least one service classifier comprises configuration of the service classifier so that the service classifier delivers, for at least one incoming packet, at least one packet enriched with the encapsulation header.

6. A method of processing an enforcement rules policy in a communications network comprising virtualized functions, called service functions (SF), the method comprising:
in at least one of the service functions (SFi), preliminary receiving, from an SDN controller of the network, a policy enforcement local context associated said the at least one service function (SFi);
receiving at least one packet enriched with an encapsulation header by a packet router, called a classifier of the network; and
processing the at least one enriched packet, in response to the policy enforcement local context associated with the at least one service function (SFi).

7. The method of processing of claim 6, wherein the processing comprises executing at least one action defined in the policy enforcement local context, in in response to at least one characteristic of the at least one enriched packet and delivering a result comprising at least one piece of information for identifying at least one service function (SFj) that is a destination of the processed enriched packet.

8. The method of processing of claim 7, wherein the processing also comprises updating the encapsulation header as a function of the result of the executing.

9. A Software-Defined Networking (SDN) controller module comprising:
means for generating, from a set of rules, called a model, describing an enforcement rules policy in a virtualized communications network comprising virtualized functions called service functions (SF), an encapsulation header comprising a context relating to a Software-Defined Networking model and to at least one policy enforcement local context associated with at least one of the service functions (SFi);
means for forwarding of the at least one local context to the service function (SFi);
means for forwarding of the encapsulation header to at least one packet router, called a classifier.

10. A virtualized function module, called a service function module, in a virtualized communications network, wherein the module comprises a policy enforcement logic module comprising:
means for reception, from a Software-Defined Networking (SDN) controller of the network, of a policy enforcement local context associated with the service function module;
means for reception of at least one packet enriched with an encapsulation header by a packet router, called a classifier of the network; and
means for processing of the at least one enriched packet in response to the policy enforcement local context.

11. A system comprising:
a Software-Defined Networking (SDN) controller comprising:
means for generating, from a set of rules, called a model, describing an enforcement rules policy in a virtualized communications network comprising virtualized functions called service functions (SF), an encapsulation header comprising a context relating to a Software-Defined Networking model and to at least one policy enforcement local context associated with at least one of the service functions (SFi);
means for forwarding of the at least one local context to the service function (SFi);
means for forwarding of the encapsulation header to at least one packet router, called a classifier;
a service function module according to claim 10; and
a packet router, called a classifier, receiving an encapsulation header from the SDN controller and delivering, for at least one incoming packet, at least one packet enriched with the encapsulation header.

12. A computing environment comprising a processor and a memory, the memory storing program code instructions executed by the processor for the implementing of the method according to of claim 1.

13. A computer-readable, non-transient information carrier on which there are stored program instructions adapted to implementing of the method of claim 1, when the program instructions are executed by a processor.
